(19) United States
(12) Patent Application Publication
(10) Pub. No.: US 2023/0019240 A1
(43) Pub. Date: Jan. 19, 2023

(54) ROTOR MOUNT ASSEMBLY

(71) Applicant: SZ DJI TECHNOLOGY CO., LTD., Shenzhen (CN)

(72) Inventor: Xiang XIAO, Shenzhen (CN)

(21) Appl. No.: 17/945,919

(22) Filed: Sep. 15, 2022

Related U.S. Application Data
(63) Continuation of application No. PCT/CN2020/079719, filed on Mar. 17, 2020.

(51) Int. Cl. B64C 39/02; B64C 27/32

(52) U.S. Cl. CPC B64C 39/024; B64C 27/32; B64C 2201/108; B64C 2201/027

(57) ABSTRACT

A propulsion system of an unmanned aerial vehicle (UAV) includes a first and a second propulsion devices each including a rotor mount assembly including a base and a lock structure arranged at the base. The lock structure includes a protrusion protruding from the base. An angle between an extension direction of the protrusion and a rotation plane of the rotor mount assembly has an absolute value larger than 0° and smaller than 90°. Each of the first and second propulsion devices further includes a rotor blade assembly configured to be locked to the corresponding rotor mount assembly by the corresponding lock structure. The rotor mount assembly of the first propulsion device is configured to not allow the rotor blade assembly of the second propulsion device to be assembled to the rotor mount assembly of the first propulsion device.

### CROSS-REFERENCE TO RELATED APPLICATION

This application is a continuation of International Application No. PCT/CN2020/079719, filed Mar. 17, 2020, the entire content of which is incorporated herein by reference.

### TECHNICAL FIELD

The present disclosure relates to technologies related to aerial vehicle (UAV) and, more particularly, to a rotor mount assembly, and a propulsion system and a UAV having the rotor mount assembly.

### BACKGROUND

An unmanned aerial vehicle (UAV) uses rotor-based propulsion system to provide a lift force for the UAV to fly in the air and move forward and backward. The propulsion system usually includes a plurality of rotor blade assemblies, such as four, six, or eight rotor blade assemblies, each of which is mounted to a body of the UAV or an arm of the UAV via a rotor mount assembly.

In conventional technologies, the rotor mount assembly and the corresponding rotor blade assembly have matching portions that match each other for clamping and fixing the rotor blade assembly to the rotor mount assembly. The mating surface of such matching portions are easily worn out, reducing the reliability of the propulsion system.

Further, due to errors in the process of manufacturing mechanical parts of the rotor mount assembly and the corresponding rotor blade assembly, the rotation axis of the rotor blade assembly may be misaligned with the driving shaft of the rotor mount assembly, which further reduces the reliability of the propulsion system.

### SUMMARY

In accordance with the present disclosure, there is provided a rotor mount assembly of an unmanned aerial vehicle (UAV) including a base and a lock structure arranged at the base. The lock structure includes a protrusion protruding from the base. An angle between an extension direction of the protrusion and a rotation plane of the rotor mount assembly is larger than 0° and smaller than 90°. The protrusion is configured to engage with a recess of a rotor blade assembly of the UAV to detachably attach the rotor blade assembly of the UAV to the base.

Also in accordance with the present disclosure, there is provided a propulsion device of a UAV including a rotor mount assembly and a rotor blade assembly. The rotor mount assembly includes a base and a lock structure arranged at the base. The lock structure includes a protrusion protruding from the base. An angle between an extension direction of the protrusion and a rotation plane of the rotor mount assembly is larger than 0° and smaller than 90°. The rotor blade assembly includes a recess. The protrusion and the recess are configured to engage with each other to detachably attach the rotor blade assembly to the base.

Also in accordance with the present disclosure, there is provided a propulsion system of a UAV including a first propulsion device and a second propulsion device. The first propulsion device includes a first rotor mount assembly and a first rotor blade assembly. The first rotor mount assembly includes a first base and a first lock structure arranged at the first base. The first lock structure includes a first protrusion protruding from the first base. An angle between an extension direction of the first protrusion and a first rotation plane of the first rotor mount assembly is larger than 0° and smaller than 90°. The first rotor blade assembly is configured to be locked to the first rotor mount assembly by the first lock structure. The second propulsion device includes a second rotor mount assembly and a second rotor blade assembly. The second rotor mount assembly includes a second base and a second lock structure arranged at the second base. The second lock structure includes a second protrusion protruding from the second base. An angle between an extension direction of the second protrusion and a second rotation plane of the second rotor mount assembly is larger than 0° and smaller than 90°. The second rotor blade assembly is configured to be locked to the second rotor mount assembly by the second lock structure. The first rotor mount assembly is configured to not allow the second rotor blade assembly to be assembled to the first rotor mount assembly.

Also in accordance with the present disclosure, there is provided a UAV including a fuselage frame and a propulsion system coupled to the fuselage frame. The propulsion system includes a first propulsion device and a second propulsion device. The first propulsion device includes a first rotor mount assembly and a first rotor blade assembly. The first rotor mount assembly includes a first base and a first lock structure arranged at the first base. The first lock structure includes a first protrusion protruding from the first base. An angle between an extension direction of the first protrusion and a first rotation plane of the first rotor mount assembly is larger than 0° and smaller than 90°. The first rotor blade assembly is configured to be locked to the first rotor mount assembly by the first lock structure. The second propulsion device includes a second rotor mount assembly and a second rotor blade assembly. The second rotor mount assembly includes a second base and a second lock structure arranged at the second base. The second lock structure includes a second protrusion protruding from the second base. An angle between an extension direction of the second protrusion and a second rotation plane of the second rotor mount assembly is larger than 0° and smaller than 90°. The second rotor blade assembly is configured to be locked to the second rotor mount assembly by the second lock structure. The first rotor mount assembly is configured to not allow the second rotor blade assembly to be assembled to the first rotor mount assembly.

Also in accordance with the present disclosure, there is provided a rotor mount assembly of a UAV including a base and a plurality of protrusions extending from the base and configured to interface with a plurality of corresponding recesses of a rotor blade assembly of the UAV for releasably attaching the rotor blade assembly of the UAV to the rotor mount assembly.

Also in accordance with the present disclosure, there is provided a rotor blade assembly of a UAV including a blade mount and an engagement structure attached to a bottom of the blade mount. The engagement structure includes a plurality of recesses configured to interface with a plurality of corresponding protrusions of a rotor mount assembly of the UAV for releasably attaching the rotor blade assembly to the rotor mount assembly.

Also in accordance with the present disclosure, there is provided a method of using a propulsion device of a UAV. The propulsion device includes a rotor mount assembly and a rotor blade assembly. The rotor mount assembly includes a base, a plurality of protrusions extending from the base, and a resilient member arranged at the base. The rotor blade assembly includes a blade mount and an engagement structure attached to a bottom of the blade mount. The engagement structure includes a plurality of recesses. The method includes applying a downward force to the rotor blade assembly to push the rotor blade assembly against the resilient member while keeping the plurality of recesses not aligned with the plurality of protrusions, until the plurality of recesses are below the plurality of protrusions, rotating the rotor blade assembly to align the plurality of recesses with the plurality of corresponding protrusions, and releasing the downward force to allow the rotor blade assembly to move upward under an effect of an elastic force of the resilient member until the plurality of recesses engage with the plurality of corresponding protrusions.

### BRIEF DESCRIPTION OF THE DRAWINGS

FIGS. 1A and 1B schematically show an example propulsion device consistent with the disclosure.

FIGS. 2A and 2B are a plan view and a front view, respectively, of an example rotor mount assembly consistent with the disclosure.

FIGS. 3A and 3B are a plan view and a front view, respectively, of an example rotor blade assembly consistent with the disclosure.

FIG. 4A is a left view of another example propulsion device consistent with the disclosure.

FIGS. 4B and 4C are a plan view and a front view of the rotor mount assembly of the propulsion device shown in FIG. 4A, respectively.

FIG. 5A is a left view of another example propulsion device consistent with the disclosure.

FIGS. 5B and 5C are a plan view and a front view of the rotor mount assembly of the propulsion device shown in FIG. 5A, respectively.

FIG. 6 is a cross-sectional view of another example propulsion device consistent with the disclosure.

FIGS. 7A and 7B schematically show portions of example lock structures of different designs consistent with the disclosure.

FIGS. 7C and 7D schematically show portions of example engagement structures of different designs consistent with the disclosure.

FIGS. 8A and 8B are flow charts showing an example method of using a propulsion device including a rotor mount assembly and a rotor blade assembly consistent with the disclosure.

FIGS. 9A-9D show the state of an example propulsion device at different stages during an assembling process and/or a dissembling process consistent with the disclosure.

FIG. 10 schematically shows an example aerial vehicle consistent with the disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings and the specification to refer to the same or like parts.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

In this disclosure, a value or a range of values may refer to a desired, target, or nominal value or range of values and can include slight variations. The term “about” or “approximately” associated with a value can allow a variation within, for example, 10% of the value, such as ±2%, ±5%, or ±10% of the value, or another proper variation as appreciated by one of ordinary skill in the art. The term “about” or “approximately” associated with a state can allow a slight deviation from the state. For example, a first component being approximately perpendicular to a second component can indicate that the first component is either exactly perpendicular to the second component or slightly deviates from being perpendicular to the second component, and an angle between the first and second components can be within a range from, e.g., 80° to 100°, or another proper range as appreciated by one of ordinary skill in the art.

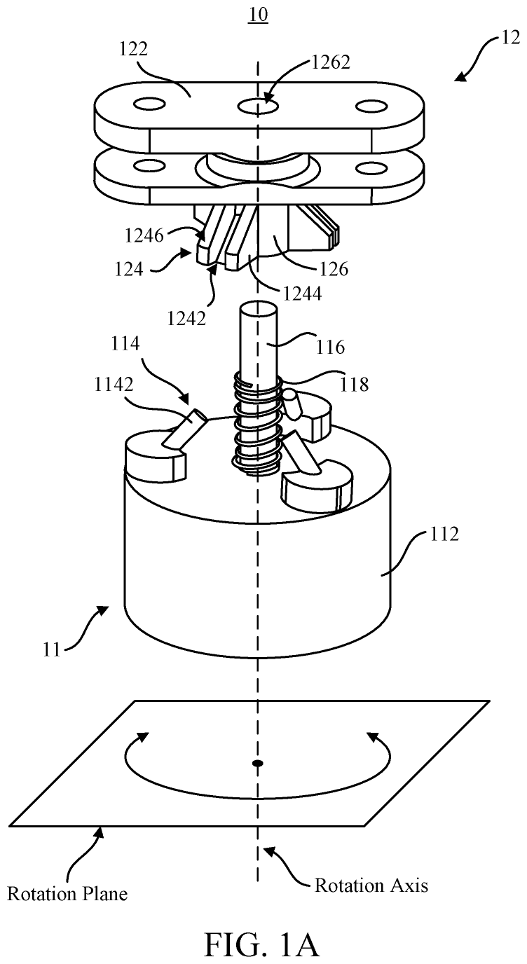

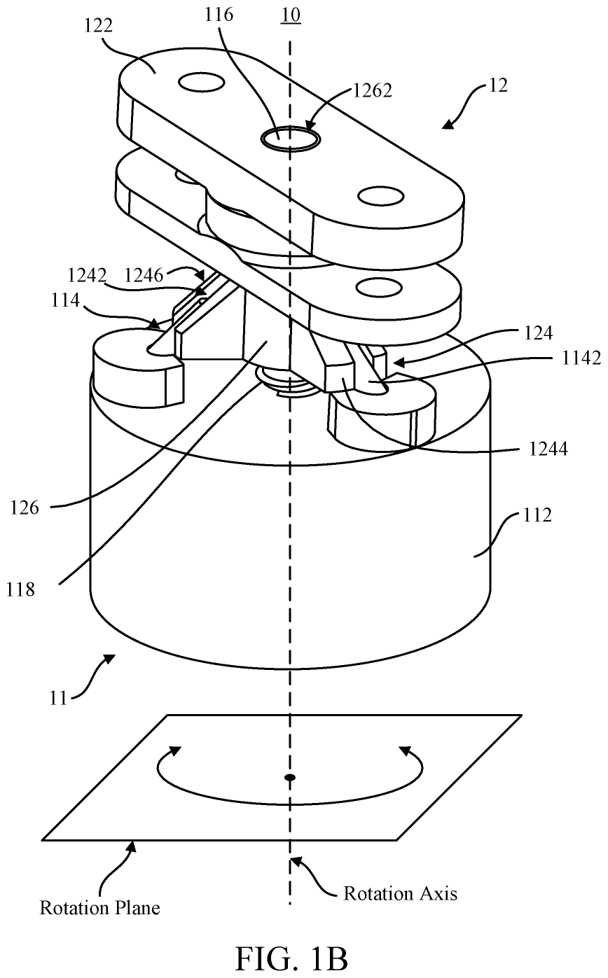

FIGS. 1A and 1B are perspective views schematically showing an example propulsion device 10 consistent with embodiments of the disclosure. The propulsion device 10 can be used with a rotor-based aerial vehicle, such as a rotor-based unmanned aerial vehicle (UAV). The UAV can be, for example, a single rotor UAV or a multi-rotor UAV, such as a two-rotor UAV, a three-rotor UAV, a four-rotor UAV, a six-rotor UAV, an eight-rotor UAV, etc. The propulsion device 10 can rotate to provide a lift force for the aerial vehicle.

As shown in FIGS. 1A and 1B, the propulsion device 10 includes a rotor mount assembly 11 and a rotor blade assembly 12 that are configured to be locked to each other. FIG. 1A shows the propulsion device 10 in a dissembled state in which the rotor blade assembly 12 is separated from the rotor mount assembly 11. FIG. 1B shows the propulsion device 10 in an assembled state in which the rotor blade assembly 12 is mounted at and locked to the rotor mount assembly 11. The blades of the rotor blade assembly 12 are not shown in FIGS. 1A and 1B. In the example shown in FIGS. 1A and 1B, the rotor blade assembly 12 is locked above the rotor mount assembly 11. In some other embodiments, the rotor blade assembly 12 can be locked below the rotor mount assembly 11, or at a middle portion of the rotor mount assembly 11.

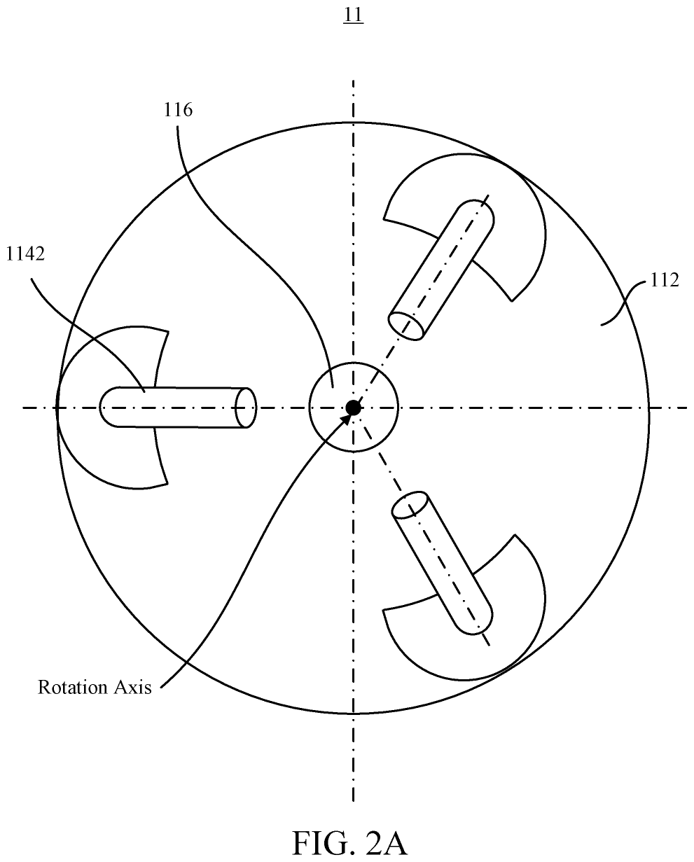

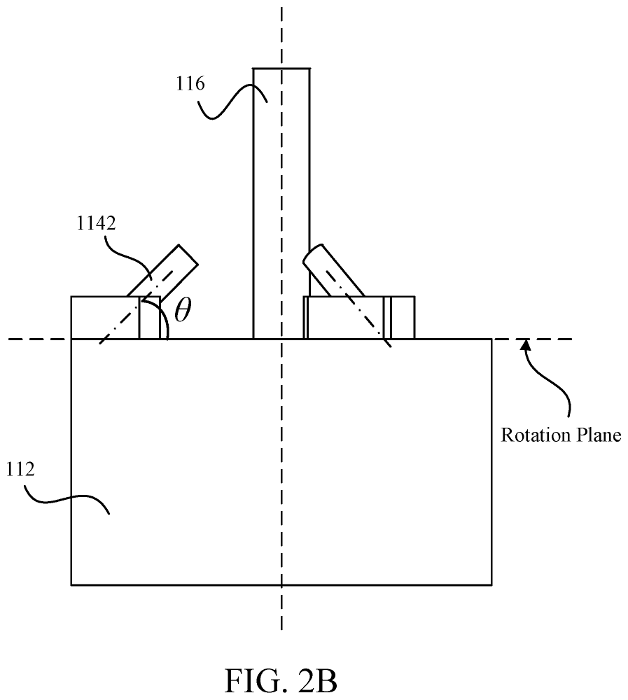

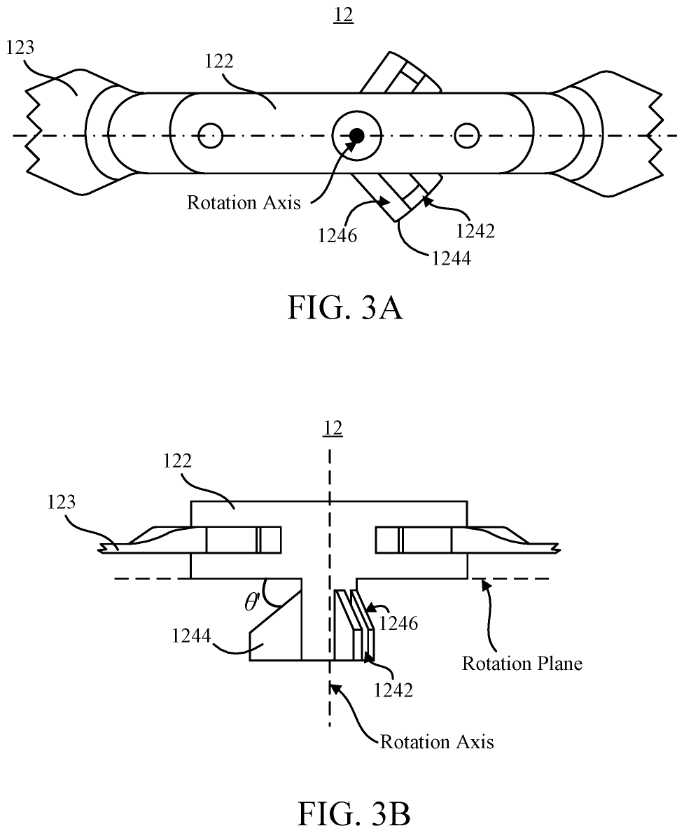

FIGS. 2A and 2B are a plan view and a front view of the rotor mount assembly 11, respectively. FIGS. 3A and 3B are a plan view and a front view of the rotor blade assembly 12, respectively. The structures of the rotor mount assembly 11 and the rotor blade assembly 12 will be described in more detail below with reference to FIGS. 1A, 1B, 2A, 2B, 3A, and 3B.

The rotor mount assembly 11 includes a base 112 and a lock structure 114 arranged at the base 112. The lock structure 114 includes a plurality of protrusions 1142 protruding/extending from the base 112.

In some embodiments, the base 112 can include a motor, such as a brush motor or a brushless motor, configured to drive the rotor blade assembly 12 to rotate via the lock structure 114. The protrusions 1142 of the lock structure 114 can be disposed at a support portion of the base 112 that is coupled to and configured to rotate together with the rotor of the motor.

In some embodiments, the motor can be an outer rotor motor. The stator of the outer rotor motor is housed inside the rotor of the outer rotor motor. For example, the outer shell of the outer rotor motor can be the rotor of the outer rotor motor, or be coupled to and configured to rotate together with the rotor of the outer rotor motor. For example, the visible portion of the base 112 in FIGS. 1A and 1B can be the outer shell of the outer rotor motor, and the protrusions 1142 of the lock structure 114 can be disposed at the outer shell of the outer rotor motor.

The plurality of protrusions 1142 can be arranged at and along a peripheral portion of the base 112. In some embodiments, the plurality of protrusions 1142 can be arranged axisymmetrically about a rotation axis of the rotor mount assembly 11. The rotor blade assembly 12 includes a blade mount 122 and two blades 123 attached to two ends of the blade mount 122, respectively (shown in FIGS. 3A and 3B). The rotor blade assembly 12 further includes an engagement structure 124 attached to a bottom of the blade mount 122. The engagement structure 124 includes a plurality of recesses 1242 matching the protrusions 1142 of the lock structure 114. In some embodiments, the plurality of recesses 1242 can be arranged axisymmetrically about a rotation axis of the rotor blade assembly 12. The plurality of protrusions 1142 and the plurality of recesses 1242 are arranged corresponding to each other, e.g., in a one-to-one correspondence, and are configured to engage/interface with each other to detachably/releasably attach the rotor blade assembly 12 to the base 112, i.e., to the rotor mount assembly 11.

In the example shown in the figures of this disclosure, the lock structure 114 includes three protrusions 1142 and correspondingly the engagement structure 124 includes three recesses 1242. The disclosure is not limited thereto. For example, in some embodiments, the lock structure 114 can include one protrusion 1142, two protrusions 1142, or four or more protrusions 1142. Correspondingly, the engagement structure 124 can include one recess 1242, two recesses 1242, or four or more recesses 1242. In some embodiments, the number of the protrusions 1142 may not equal the number of the recesses 1242. For example, there may be more protrusions 1142 than the recesses 1242, or may be less protrusions 1142 than the recesses 1242.

In some embodiments, to realize the engagement/interfacing between the protrusions 1142 and the recesses 1242, the shape and size of a protrusion 1142 can match the shape and size of a corresponding recess 1242. For example, as shown in FIGS. 1A-2B, the protrusion 1142 includes a column having an elongated shape. The cross-section of the column can have at least one of a circular shape or a polygonal shape, such as at least one of a round shape, an irregular circular shape, an elliptical shape, a rectangular shape, or a triangular shape. Correspondingly, as shown in FIGS. 1A, 1B, 3A, and 3B, the recess 1242 includes a trench also having an elongated shape. The cross-section of the trench can have a shape that can accommodate the column. For example, if the cross-section of the protrusion 1142 has a round shape, the cross-section of the corresponding recess 1242 can have a semi-circular shape or an arc shape corresponding to a central angle of slightly larger than 180° or smaller than 180°.

In some embodiments, one or both of the lock structure 114 and the engagement structure 124 can be at least partially made from an elastic material. Such as at least one of elastomer or metal. For example, the protrusions 1142 can be made from an elastic material and/or the portions of the engagement structure 124 on which the recesses are formed can be made from an elastic material.

To realize the engagement/interfacing between the protrusions 1142 and the recesses 1242, in addition to the shape and/or size matching between the protrusions 1142 and the recesses 1242, the spatial arrangements and orientations of the protrusions 1142 and the recesses 1242 can also match. For example, as shown in FIGS. 1A-3B, the protrusions 1142, and correspondingly the recesses 1242, are obliquely arranged, as will be described in more detail below.

In some embodiments, the protrusions 1142 can be obliquely arranged with respect to, i.e., are not perpendicular to, a rotation plane of the rotor mount assembly 11, e.g., an angle between an extension direction of a protrusion 1142 (axial direction of the protrusion 1142) and the rotation plane of the rotor mount assembly 11, also referred to as a “tilt angle of the protrusion 1142,” has an absolute value larger than 0° and smaller than 90° (i.e., an acute angle). The rotation plane of the rotor mount assembly 11 may refer to a plane defined by a movement path of any point on the rotor mount assembly 11, i.e., the plane on which the movement path of such point lies, while the rotor mount assembly 11 rotates about the rotation axis of the rotor mount assembly 11.

As shown in FIGS. 1A, 1B, 2A, and 2B, the protrusions 1142 are arranged at the base 112 and extend from the base 112 inwardly toward the rotation axis of the rotor mount assembly 11. For example, a protrusion 1142 can intersect with the base 112, such as a top surface of the base 112, at a joint point, which is also referred to as a “protrusion-base joint point.” The protrusion 1142 can form an acute angle with a projection line from the protrusion-base joint point to the rotation axis of the rotor mount assembly 11. This projection line is also referred to as a “protrusion projection line.” In some embodiments, the protrusion projection line can intersect with the rotation axis of the rotor mount assembly 11 at a joint point between the rotation axis of the rotor mount assembly 11 and the base 112, such as a joint point between the rotation axis of the rotor mount assembly 11 and the top surface of the base 112. This joint point is also referred to as an “axis-base joint point.” The protrusion projection line can coincide with or be parallel to a radial direction of the rotation plane of the rotor mount assembly 11 that passes through the protrusion-base joint point.

In some embodiments, as shown in FIG. 2B, a top surface of the base 112 or a portion of the top surface of the base 112 approximately coincides with or be approximately parallel to the rotation plane of the rotor mount assembly 11. Angle θ in FIG. 2B represents the angle between the extension direction of the protrusion 1142 and the rotation plane of the rotor mount assembly 11, which, in this example, is also the angle between the extension direction of the protrusion 1142 and the top surface of the base 112. As shown in FIG. 2B, the angle θ has an absolute value larger than 0° and smaller than 90°.

In some other embodiments, the top surface of the base 112 can include a planar surface or a planar portion that is not parallel to the rotation plane of the rotor mount assembly 11. In some embodiments, the top surface of the base 112 can include a non-planar surface or a non-planar portion. The non-planar surface or non-planar portion can be convex or partially convex, or concave or partially concave, or partially convex and partially concave.

Correspondingly, the recesses 1242 of the engagement structure 124 can be obliquely arranged with respect to, i.e., are not perpendicular to, a rotation plane of the rotor blade assembly 12, e.g., an angle between an extension direction of a recess 1242 (a length direction of the recess 1242) and the rotation plane of the rotor blade assembly 12, also referred to as a “tilt angle of the recess 1242,” has an absolute value larger than 0° and smaller than 90° (i.e., an acute angle). The rotation plane of the rotor blade assembly 12 may refer to a plane defined by a movement path of any point on the rotor blade assembly 12, i.e., the plane on which the movement path of such point lies, while the rotor blade assembly 12 rotates about the rotation axis of the rotor blade assembly 12. Consistent with the disclosure, the tilt angle of a recess 1242 can be approximately the same as the tile angle of the corresponding protrusion 1142.

After the propulsion device 10 is assembled, i.e., after the rotor blade assembly 12 is mounted and locked to the rotor mount assembly 11, the rotation axis of the rotor blade assembly 12 can approximately coincide with the rotation axis of the rotor mount assembly 11, and, similarly, the rotation plane of the rotor blade assembly 12 can approximately coincide with or be approximately parallel to the rotation plane of the rotor mount assembly 11. In FIGS. 1A and 1B, only one rotation plane and one rotation axis are shown to indicate but they can be for both the rotor blade assembly 12 and the rotor mount assembly 11.

As shown in FIGS. 1A, 1B, 3A, and 3B, the recesses 1242 extend outwardly away from the rotation axis of the rotor blade assembly 12. That is, a first end of a recess 1242 that is closer to the rotation axis of the rotor blade assembly 12 than a second end of the recess 1242 is also closer to the blade mount 122 than the second end of the recess 1242. The recess 1242 can form an acute angle with a projection line from the second end of the recess 1242 to the rotation axis of the rotor blade assembly 12. This projection line is also referred to as a “recess projection line.” In this disclosure, the end of a recess 1242 that is closer to the blade mount 122 than the other end of the recess 1242 is also referred to as a “proximal end” of the recess 1242, and correspondingly the other end of the recess 1242 is also referred to as a “distal end” of the recess 1242. The recess projection line can coincide with or be parallel to a radial direction of the rotation plane of the rotor blade assembly 12 that passes through the distal end of the recess 1242.

In some embodiments, as shown in FIG. 3B, a bottom surface of the blade mount 122 or a portion of the bottom surface of the blade mount 122 approximately coincides with or be approximately parallel to the rotation plane of the rotor blade assembly 12. Angle θ′ in FIG. 3B represents the angle between the extension direction of the recess 1242 and the rotation plane of the rotor blade assembly 12, which, in this example, is also the angle between the extension direction of the recess 1242 and the bottom surface of the blade mount 122. The angle θ′ in FIG. 3B can be approximately the same as the angle θ in FIG. 2B. As shown in FIG. 3B, the angle θ′ has an absolute value larger than 0° and smaller than 90°. As a result of the spatial orientations of the recesses 1242 and the protrusions 1142, when the rotor blade assembly 12 is mounted and locked to the rotor mount assembly 11, the extension direction of a recess 1242 can be approximately the same as the extension direction of a corresponding protrusion 1142.

In some other embodiments, the bottom surface of the blade mount 122 can include a planar surface or a planar portion that is not parallel to the rotation plane of the rotor blade assembly 12. In some embodiments, the bottom surface of the blade mount 122 can include a non-planar surface or a non-planar portion. The non-planar surface or non-planar portion can be convex or partially convex, or concave or partially concave, or partially convex and partially concave.

In the example shown in FIGS. 1A, 1B, 2A, and 2B, a line at which a protrusion 1142 is located, also referred to as a “protrusion line” of the protrusion 1142, can intersect the rotation axis of the rotor mount assembly 11. That is, the protrusion line and the rotation axis of the rotor mount assembly 11 can be on a same plane and are not parallel to each other. Thus, in this example, the angle between the extension direction of a protrusion 1142 and the rotation plane of the rotor mount assembly 11, e.g., angle θ shown in FIG. 2B, is the same as the angle between the protrusion 1142 and the protrusion projection line from the corresponding protrusion-base joint point to the rotation axis of the rotor mount assembly 11 (such an angle is also referred to as a “protrusion-projection angle”). In some embodiments, the protrusion line of a protrusion 1142 can coincide with an axis of the protrusion 1142.

Correspondingly, in the example shown in FIGS. 1A, 1B, 3A, and 3B, a line at which a recess 1242 is located, also referred to as a “recess line” of the recess 1242, can intersect the rotation axis of the rotor blade assembly 12, i.e., the recess line and the rotation axis of the rotor blade assembly 12 can be on a same plane and are not parallel to each other. Thus, in this example, the angle between the extension direction of a recess 1242 and the rotation plane of the rotor mount assembly 12, e.g., angle θ′ shown in FIG. 3B, is the same as the angle between the recess 1242 and the recess projection line from the distal end of the recess 1242 to the rotation axis of the rotor mount assembly 11 (such an angle is also referred to as a “recess-projection angle”). In some embodiments, the recess line of a recess 1242 can coincide with an axis of the recess 1242.

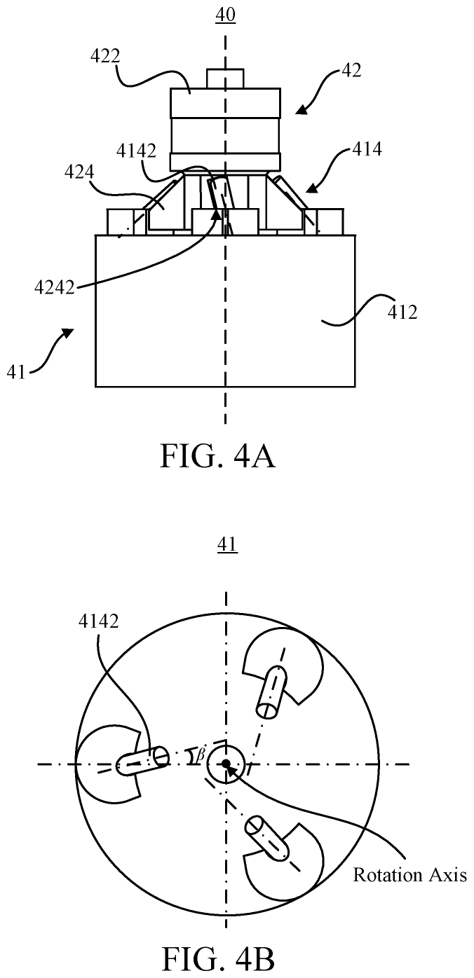

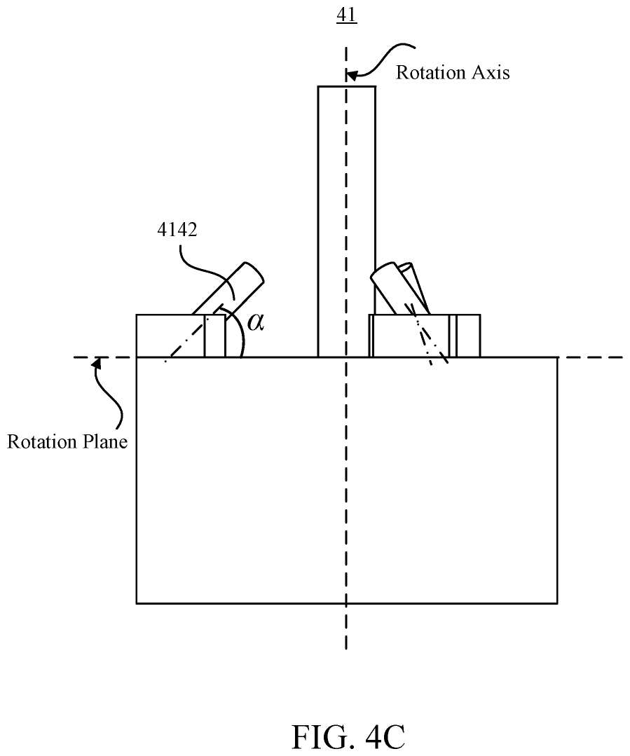

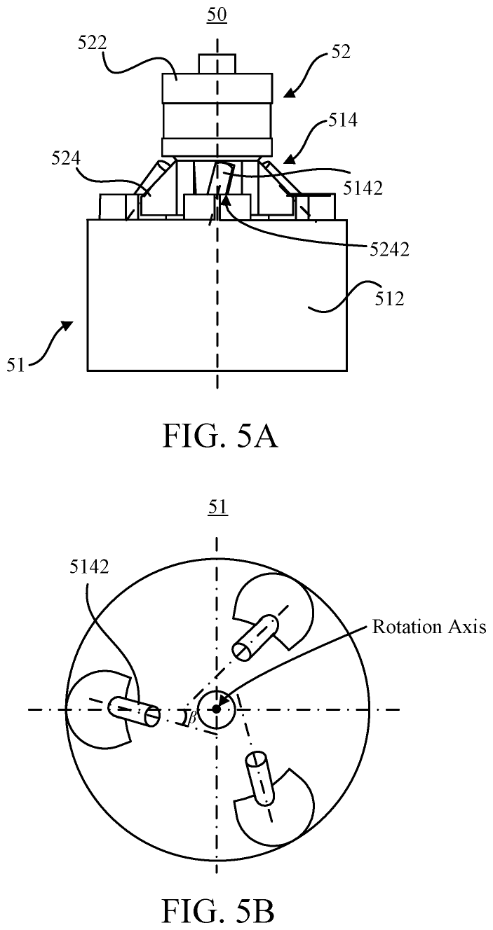

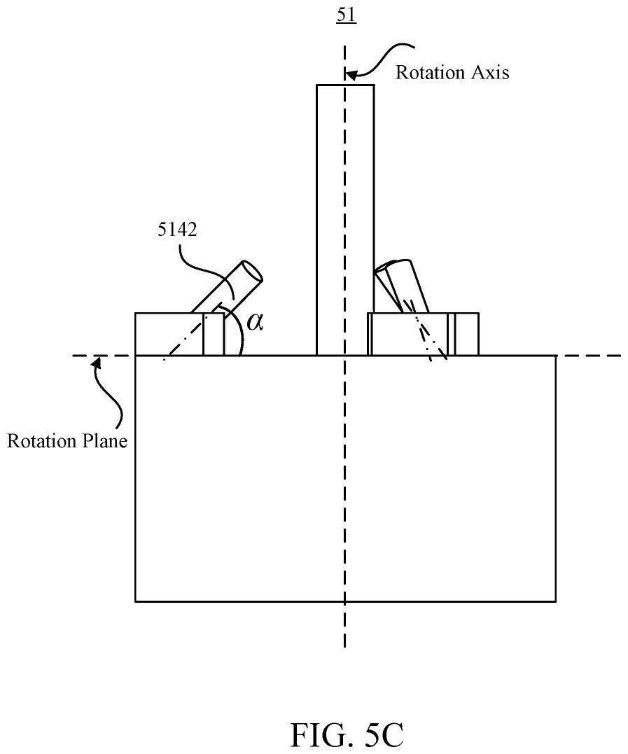

In some other embodiments, the protrusion line of at least one protrusion of the rotor mount assembly does not intersect, i.e., is not on a same plane as, the rotation axis of the rotor mount assembly. Correspondingly, the recess line of at least one recess of the rotor blade assembly does not intersect, i.e., is not on a same plane as, the rotation axis of the rotor blade assembly. Examples of propulsion device having such protrusion(s) and such recess(es) are described in more detail below in connection with FIGS. 4A-4C and 5A-5C.

FIG. 4A is a left view of another example propulsion device 40 consistent with the disclosure. The propulsion device 40 includes a rotor mount assembly 41 and a rotor blade assembly 42 that are configured to be locked to each other. FIG. 4A shows the propulsion device 40 in the assembled state. FIGS. 4B and 4C are a plan view and a front view of the rotor mount assembly 41, respectively. As shown in FIGS. 4A-4C, the rotor mount assembly 41 includes a base 412 and a lock structure 414 arranged at the base 412. The lock structure 414 includes a plurality of protrusions 4142 protruding/extending from the base 412. Correspondingly, as shown in FIG. 4A, the rotor blade assembly 42 includes a blade mount 422 and an engagement structure 424 attached to a bottom of the blade mount 422. The engagement structure 424 includes a plurality of recesses 4242 matching the protrusions 4142 of the lock structure 414. The blades of the rotor blade assembly 42 are not shown in FIG. 4A.

Consistent with the disclosure, the rotor mount assembly 41 differs from the rotor mount assembly 11 in terms of the orientations of the protrusions, but can otherwise be similar to the rotor mount assembly 11. Correspondingly, the rotor blade assembly 42 differs from the rotor blade assembly 12 in terms of the orientations of the recesses, but can otherwise be similar to the rotor blade assembly 12. The descriptions of the propulsion device 10 are also applicable to the propulsion device 40 where appropriate, e.g., for similar components and/or features. The details about the protrusions 4142 of the rotor mount assembly 41 are described below in connection with FIGS. 4A-4C. The recesses 4242 of the rotor blade assembly 42 are configured to match the protrusions 4142. The configurations, such as orientations, of the recesses 4242 correspond to those of the protrusions 4142, and hence detailed description thereof is omitted.

As shown in FIGS. 4A and 4C, similar to the protrusions 1142 of the rotor mount assembly 11 described above, the protrusions 4142 are obliquely arranged with respect to, i.e., are not perpendicular to, a rotation plane of the rotor mount assembly 41, and extend inwardly approximately toward the rotation axis of the rotor mount assembly 41. For example, the tilt angle of a protrusion 4142 has an absolute value larger than 0° and smaller than 90° (i.e., an acute angle). The protrusion 4142 also forms an acute angle with a protrusion projection line from the corresponding protrusion-base point to the rotation axis of the rotor mount assembly 41. However, since the protrusion line of the protrusion 4142 does not intersect, i.e., is not on a same plane as, the rotation axis of the rotor mount assembly 41, the angle between the protrusion 4142 and the corresponding protrusion projection line (the protrusion-projection angle) is different from the tilt angle of the protrusion 4142.

The protrusion-projection angle corresponding to a protrusion 4142 can be decomposed into two components, as shown in FIGS. 4B and 4C. The protrusion projection line corresponding to the protrusion 4142 and the rotation axis of the rotor mount assembly 41 define a plane, e.g., the paper plane in FIG. 4C. In this disclosure, this plane is also referred to as a “protrusion projection plane.” One component of the protrusion-projection angle is an angle between the protrusion projection line and a projection of the protrusion 4142 on the protrusion projection plane. This component is also referred to as an “out-of-plane component” of the protrusion-projection angle, and is denoted as a in FIG. 4C. The other component of the protrusion-projection angle is an angle between a projection of the protrusion 4142 on the rotation plane and the protrusion projection line. This component is also referred to as an “in-plane component” of the protrusion-projection angle, and is denoted as β in FIG. 4B. As shown in FIGS. 4B and 4C, both angles α and β are acute angles, i.e., having an absolute value larger than 0° and smaller than 90°.

In the example shown in FIGS. 4A-4C, the protrusions 4142 are arranged helically about the rotation axis of the rotor mount assembly 41. In particular, in this example, the protrusions 4142 are arranged to have a left-handed helicity (a clockwise helicity seeing from above), i.e., the protrusions 4142 form a left-handed helix. The helicity of the protrusions 4142 can also be defined in terms of angles α and β, as described in more detail below.

An xyz coordinate system can be defined for assisting the descriptions, for example, as shown in FIGS. 4A-4C. In this coordinate system, the x-y plane is parallel to the rotation plane of the rotor mount assembly 41, and the x-z plane is perpendicular to the rotation plane of the rotor mount assembly 41 and passes through the protrusion-base joint of a protrusion 4142 and the rotation axis of the rotor mount assembly 41. Further, the positive x-direction points from the protrusion-base joint of the protrusion 4142 towards the rotation axis of the rotor mount assembly 41, and the positive z-direction is the direction pointing away from the base 412, i.e., the upward direction in FIG. 4C. In this coordinate system, an angle from the positive x-direction toward the positive z-direction is regarded as a positive angle and an angle from the positive x-direction toward the negative z-direction is regarded as a negative angle. Further, an angle from the positive x-direction toward the positive y-direction is regarded as a positive angle and an angle from the positive x-direction toward the negative y-direction is regarded as a negative angle.

With the coordinate system and the convention for signs of angles defined in last paragraph, the helicity of the protrusions 4142 can be described using angles α and β. In the example shown in FIGS. 4A-4C, 0°<α<90° and 0°<β<90°, the protrusions 4142 have a left-handed helicity (clockwise helicity). In another example (not shown in the figures), −90°<α<0° and −90°<β<0°, and the protrusions 4142 also have a left-handed helicity (clockwise helicity). The protrusions 4142 having a left-handed helicity are also referred to as left-handed protrusions, and the lock structure including the left-handed protrusions is also referred to as a left-handed lock structure. Correspondingly, the recesses to engage with the left-handed protrusions are also referred to as left-handed recesses, and the engagement structure including the left-handed recesses is also referred to a left-handed engagement structure.

FIG. 5A is a left view of another example propulsion device 50 consistent with the disclosure. The propulsion device 50 includes a rotor mount assembly 51 and a rotor blade assembly 52 that are configured to be locked to each other. FIG. 5A shows the propulsion device 50 in the assembled state. FIGS. 5B and 5C are a plan view and a front view of the rotor mount assembly 51, respectively. As shown in FIGS. 5A-5C, the rotor mount assembly 51 includes a base 512 and a lock structure 514 arranged at the base 512. The lock structure 514 includes a plurality of protrusions 5142 protruding/extending from the base 512. Correspondingly, as shown in FIG. 5A, the rotor blade assembly 52 includes a blade mount 522 and an engagement structure 524 attached to a bottom of the blade mount 522. The engagement structure 524 includes a plurality of recesses 5242 matching the protrusions 5142 of the lock structure 514. The blades of the rotor blade assembly 52 are not shown in FIG. 5A.

Consistent with the disclosure, the rotor mount assembly 51 differs from the rotor mount assembly 11 and the rotor mount assembly 41 in terms of the orientations of the protrusions, but can otherwise be similar to the rotor mount assembly 11 and the rotor mount assembly 41. Correspondingly, the rotor blade assembly 52 differs from the rotor blade assembly 12 and the rotor blade assembly 42 in terms of the orientations of the recesses, but can otherwise be similar to the rotor blade assembly 12 and the rotor blade assembly 42. The descriptions of the propulsion device 10 and the propulsion device 40 are also applicable to the propulsion device 50 where appropriate, e.g., for similar components and/or features. The details about the protrusions 5142 of the rotor mount assembly 51 are described below in connection with FIGS. 5A-5C. The recesses 5242 of the rotor blade assembly 52 are configured to match the protrusions 5142. The configurations, such as orientations, of the recesses 5242 correspond to those of the protrusions 5142, and hence detailed description thereof is omitted.

As shown in FIGS. 5A-5C, similar to the protrusions 4142 of the rotor mount assembly 41 described above, the protrusions 5142 of the rotor mount assembly 51 are helically arranged about the rotation axis of the rotor mount assembly 51. However, different from the protrusions 4142 of the rotor mount assembly 41, the protrusions 5142 of the rotor mount assembly 51 are arranged to have a right-handed helicity (a counter-clockwise helicity seeing from the above), i.e., the protrusions 5142 form a right-handed helix. Similar to the situation with the protrusions 4142, the helicity of the protrusions 5152 can also be defined in terms of the out-of-plane component of the protrusion-projection angle, i.e., angle α, associated with a protrusion 5152 and the in-plane component of the protrusion-projection angle, i.e., angle β, associated with the protrusion 5152.

In the example shown in FIGS. 5A-5C, 0°<α<90° and −90°<β<0°, the protrusions 5142 have a right-handed helicity (counter-clockwise helicity). In another example (not shown in the figures), −90°<α<0° and 0°<β<90°, and the protrusions 5142 also have a right-handed helicity (counter-clockwise helicity). The protrusions 5142 having a right-handed helicity are also referred to as right-handed protrusions, and the lock structure including the right-handed protrusions is also referred to as a right-handed lock structure. Correspondingly, the recesses to engage with the right-handed protrusions are also referred to as right-handed recesses, and the engagement structure including the right-handed recesses is also referred to a right-handed engagement structure.

As described above, the helicity of protrusions (and hence corresponding recesses) can be determined according to angles α and β defined above. If 0°<α<90° and 0°<β<90°, or if −90°<α<0° and −90°<β<0°, the protrusions (and hence the corresponding recesses) have a left-handed helicity, such as shown in FIGS. 4A-4C. If 0°<α<90° and −90°<β<0°, or if −90°<α<0° and 0°<β<90°, the protrusions (and hence the corresponding recesses) have a right-handed helicity, such as shown in FIGS. 5A-5C. If β=0°, the protrusions (and hence the corresponding recesses) have no helicity, such as shown in FIGS. 1A-3B. That is, consistent with the disclosure, the orientation of a protrusion (and hence the corresponding recess) can be described using angles α and β, and the example shown in FIGS. 1A-3B can be considered as a special case where β=0.

Other features of a propulsion device consistent with the disclosure will be further described below with reference to propulsion device 10 in FIGS. 1A-3B. These features can be common among the propulsion device 10, the propulsion device 40, and the propulsion device 50, and therefore the descriptions can be also applicable to the propulsion device 40 and the propulsion device 50.

The rotor mount assembly 11 further includes a shaft 116 arranged at a center of the base 112. Correspondingly, the rotor blade assembly 12 includes a shaft receiving member 126 arranged at a center of the blade mount 122. In the example shown in the figures, the shaft receiving member 126 has a cylindrical shape. In some other embodiments, the shaft receiving member 126 can have another shape, such as a square column shape or a rectangular column shape.

The shaft receiving member 126 has a shaft hole 1262 for receiving the shaft 116. The shaft 116 is configured to be connected to the rotor blade assembly 12 by being inserted in the shaft hole 1262, and hence to drive the rotor blade assembly 12 to rotate. In the example shown in the figures, the shaft 116 and the shaft hole 1262 each have a circular cross-section. In some other embodiments, the cross-section of each of the shaft 116 and the shaft hole 1262 can have another shape, such as an oval shape, a rectangular shape, or a square shape.

As shown in, e.g., FIG. 1A, the rotor mount assembly 11 further includes a resilient member 118 arranged at the base 112 and configured to provide an elastic force on the rotor blade assembly 12 when the rotor blade assembly 12 is mounted to the rotor mount assembly 11, e.g., to push the rotor blade assembly 12 away from the base 112 when the rotor blade assembly 12 is releasably attached to the rotor mount assembly 11. For example, as shown in FIG. 1B, when the propulsion device 10 is in the assembled state, the resilient member 118 is in a compressed state and abuts against the rotor blade assembly 12, e.g., against the shaft receiving member 126 of the rotor blade assembly 12, to push the rotor blade assembly 12 upward. As a result, the recesses 1242 of the rotor blade assembly 12 are pushed against the protrusions 1142 of the rotor mount assembly 11, resulting in the engagement/interfacing between the protrusions 1142 and the recesses 1242, and hence the engagement between the rotor mount assembly 11 and the rotor blade assembly 12.

In some embodiments, the resilient member 118 can be made of an elastic material. The elastic material can include at least one of elastomer or metal. In some embodiments, the resilient member 118 can include a spring structure. The spring structure can include at least one of a flat spring, a coil spring, a hydraulic spring, or a gas spring. In some embodiments, as shown in FIGS. 1A and 1B, the resilient member 118 is sleeved on the shaft 116. In some embodiments, the shaft 116 can be omitted and the rotor blade assembly 12 can be fixed to the rotor mount assembly 11 through the engagement/interfacing between the protrusions 1142 and the recesses 1242, and the elastic force exerted on the rotor blade assembly 12 by the resilient member 118.

In some embodiments, as shown in, e.g., FIGS. 1A, 1B, and 3B, the engagement structure 124 includes a plurality of side bumps 1244 protruding from a peripheral surface of the shaft receiving member 126. Each of the recesses 1242 is formed at one of the plurality of side bumps 1244. Specifically, a side bump 1244 includes an inclined surface 1246 inclined relative to the peripheral surface of the shaft receiving member 126 and a corresponding recess 1242 is formed on the inclined surface 1246.

In the examples described above, the protrusions are arranged at the peripheral portion of the base and extend inwardly toward the rotation axis of the rotor mount assembly. Correspondingly, the recesses are arranged close to the center (the rotation axis) of the rotor blade assembly and extend outwardly away from the rotation axis of the rotor blade assembly. In some other embodiments, the positions of the protrusions and the recesses on the rotor mount assembly and the rotor blade assembly, respectively, can be different from those described above. For example, in some embodiments, the protrusions can be disposed around a center portion of the rotor mount assembly and extend outwardly away from the rotation axis of the rotor mount assembly; and correspondingly, the recesses can be disposed at a peripheral portion of the rotor mount of the rotor blade assembly and extend inwardly toward the rotation axis of the rotor blade assembly.

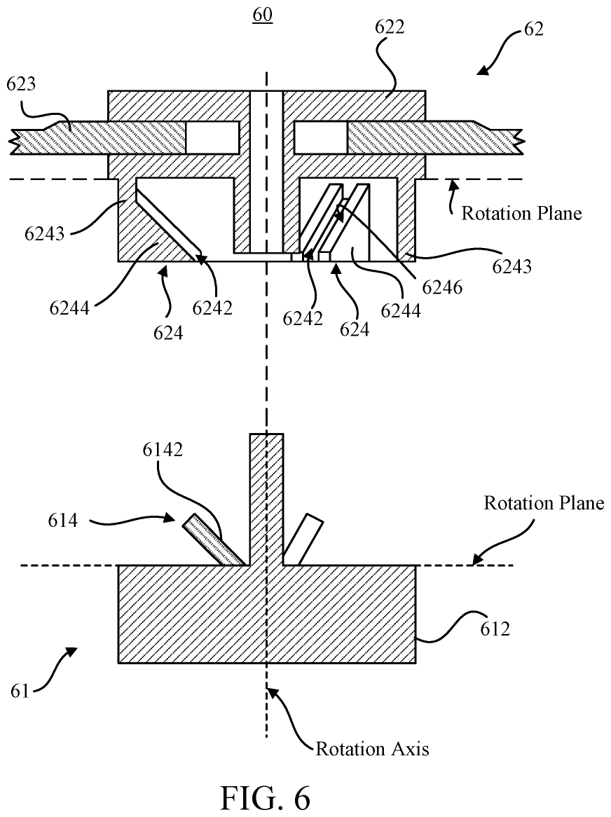

FIG. 6 is a cross-sectional view of another example propulsion device 60 consistent with the disclosure. The propulsion device 60 can be similar to the example propulsion devices 10, 40, and 50 described above, and the descriptions of the features of the propulsion device 60 that are same as to similar to those of the propulsion device 10, the propulsion device 40, and/or the propulsion device 50 are omitted.

As shown in FIG. 6, the propulsion device 60 includes a rotor mount assembly 61 and a rotor blade assembly 62. The rotor mount assembly 61 includes a base 612 and a lock structure 614 formed at the base 612. The lock structure 614 includes a plurality of protrusions 6142. Different from the protrusions of the propulsion devices 10, 40, and 50 described above, the protrusions 6142 of the propulsion device 60 are disposed around a center portion of the rotor mount assembly 61 and extend outwardly away from the rotation axis of the rotor mount assembly 61. That is, a protrusion 6142 forms an obtuse angle (having an absolute value larger than 90° and smaller than 180°) with the corresponding protrusion projection line.

The rotor blade assembly 62 includes a blade mount 622 for mounting blades 623 of the rotor blade assembly 62. The rotor blade assembly 62 further includes an engagement structure 624 formed at a bottom of the blade mount 622. The engagement structure 624 includes a plurality of recesses 6242 matching the protrusions 6142 of the lock structure 614. As described above, the protrusions 6142 extend outwardly away from the rotation axis of the rotor mount assembly 61. To realize the engagement/interfacing between the protrusions 6142 and the recesses 6242, the recesses 6242 are formed to extend inwardly towards the rotation axis of the rotor blade assembly. That is, the proximal end of a recess 6242 is farther away from the rotation axis of the rotor blade assembly 62 than the distal end of the recess 6242, as shown in FIG. 6. Thus, recess 6242 forms an obtuse angle (having an absolute value larger than 90° and smaller than 180°) with the corresponding recess projection line, which is a projection line from the distal end of the recess 6242 to the rotation axis of the rotor blade assembly 62.

As shown in FIG. 6, the engagement structure 624 includes a peripheral wall 6243 extending from the bottom of the blade mount 622 and a plurality of side bumps 6244 protruding from an inner surface of the peripheral wall 6243. Each of the side bumps 6244 includes an inclined surface 6246 inclined relative to the inner surface of the peripheral wall 6243, as shown in FIG. 6. Each of the recesses 6242 is formed on the inclined surface 6246 of one of the side bumps 6244.

In the example shown in FIG. 6, the peripheral wall 6243 is a 360° wall completely surrounding the peripheral of the space below the blade mount 622. In some other embodiments, the engagement structure 624 can include one or more peripheral walls each corresponding to a central angle smaller than 360°. This disclosure does not limit the number, shape, and size of the peripheral walls, as long as they can support the side bumps 6244 for forming the recesses 6242. In some other embodiments, the peripheral wall(s) can be omitted and the side bumps 6244 can be formed at the bottom of the blade mount 622 directly.

In some embodiments, the lock structure and the engagement structure of a propulsion device consistent with the disclosure, such as one of the propulsion devices 10, 40, 50, and 60 described above, can be configured in such a manner that the engagement structure can only be rotated to the proper position and hence engage with the lock structure when the rotor blade assembly is pushed against the resilient member of the rotor mount assembly and rotated in a first direction, but cannot be rotated to the proper position to engage with the lock structure when the rotor blade assembly is rotated in a second direction opposite to the first direction. For example, the first direction can be the clockwise direction (seeing from above) and correspondingly the second direction can be the counter-clockwise direction (seeing from above). As another example, the first direction can be the counter-clockwise direction and correspondingly the second direction can be the clockwise direction.

More specifically, at least one of the lock structure and the engagement structure of the propulsion device can be configured such that the protrusions of the lock structure are capable of engaging with the corresponding recesses of the engagement structure when the rotor blade assembly is rotating relative to the rotor mount assembly in the first direction but not capable of engaging with the recesses when the rotor blade assembly is rotating relative to the rotor mount assembly in the second direction.

The design that requires the rotor blade assembly to rotate in a certain direction relative to the rotor mount assembly to allow the engagement structure to rotate to the proper position (also referred to as “engagement position”) to engage with the lock structure is also referred to as a one-direction engagement design. The one-direction engagement design can be realized using various manners, for example, by adding one or more additional features to at least one of the rotor blade assembly or the rotor mount assembly to block the rotation of the rotor blade assembly in one direction. The one-direction engagement design that allows the engagement structure to rotate to the engagement position when the rotor blade assembly rotates relative to the rotor mount assembly in a clockwise direction (seeing from above) is also referred to as a “clockwise engagement design”), and the one-direction engagement design that allows the engagement structure to rotate to the engagement position when the rotor blade assembly rotates relative to the rotor mount assembly in a counter-clockwise direction (seeing from above) is also referred to as a “counter-clockwise engagement design”).

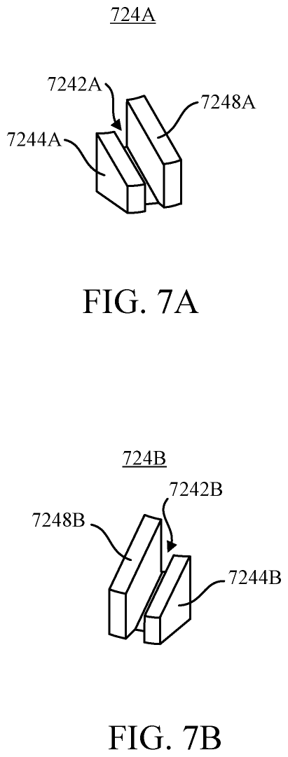

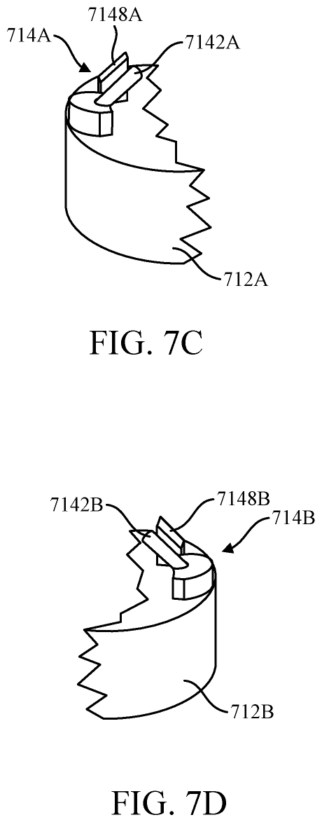

FIGS. 7A and 7B schematically show portions of example lock structures 714A and 714B having a clockwise engagement design and a counter-clockwise engagement design, respectively, consistent with the disclosure. In each of FIGS. 7A and 7B, protrusion of the corresponding engagement structure is shown. FIGS. 7C and 7D schematically show portions of example engagement structures 724A and 724B having a clockwise engagement design and a counter-clockwise engagement design, respectively, consistent with the disclosure. In each of FIGS. 7C and 7D, one side bump of the corresponding engagement structure is shown.

The lock structure 714A has a clockwise engagement design. As shown in FIG. 7A, the lock structure 714A includes a protrusion 7142A protruding from a base 712A and a blocking member 7148A arranged at the left side of the protrusion 7142A, i.e., the clockwise side (seeing from above) of the protrusion 7142A. When the rotor blade assembly rotates relative to the rotor mount assembly including the lock structure 714A in the clockwise direction, the protrusion 7142A can pass over the side bump of the engagement structure of the rotor mount assembly from the left side of the recess on the side bump to align with the recess. However, further rotation of the rotor blade assembly in the clockwise direction (relative movement of the protrusion 7142A) can be blocked by the blocking member 7148A when the side bump contacts the blocking member 7148A. On the other hand, if the rotor blade assembly rotates relative to the rotor mount assembly including the lock structure 714A in the counter-clockwise direction, the side bump of the corresponding engagement structure will be blocked by the blocking member 7148A and hence cannot rotate to the position that allows the recess to align with the protrusion 7142A.

On the other hand, the lock structure 714B has a counter-clockwise engagement design. As shown in FIG. 7B, the lock structure 714B includes a protrusion 7142B protruding from a base 712B and a blocking member 7148B arranged at the right side of the protrusion 7142B, i.e., the counter-clockwise side (seeing from above) of the protrusion 7142B. When the rotor blade assembly rotates relative to the rotor mount assembly including the lock structure 714B in the counter-clockwise direction, the protrusion 7142B can pass over the side bump of the engagement structure of the rotor mount assembly from the right side of the recess on the side bump to align with the recess. However, further rotation of the rotor blade assembly in the counter-clockwise direction (relative movement of the protrusion 7142B) can be blocked by the blocking member 7148B when the side bump contacts the blocking member 7148B. On the other hand, if the rotor blade assembly rotates relative to the rotor mount assembly including the lock structure 714B in the clockwise direction, the side bump of the corresponding engagement structure will be blocked by the blocking member 7148B and hence cannot rotate to the position that allows the recess to align with the protrusion 7142B.

The engagement structure 724A has a clockwise engagement design. As shown in FIG. 7C, the engagement structure 724A includes a side bump 7244A protruding from a peripheral surface of a shaft receiving member (not shown in FIG. 7C). A recess 7242A is formed on the side bump 7244A. The engagement structure 724A further includes a blocking member 7248A arranged at the right side of the recess 7242A, i.e., the counter-clockwise side (seeing from above) of the recess 7242A. When the rotor blade assembly including the engagement structure 724A rotates relative to the corresponding rotor mount assembly in the clockwise direction, the protrusion of the corresponding lock structure can pass over the side bump 7244A from the left side of the recess 7242A to align with the recess 7242A. However, further movement of the protrusion can be blocked by the blocking member 7248A when the protrusion contacts the blocking member 7248A. On the other hand, if the rotor blade assembly including the engagement structure 724A rotates relative to the corresponding rotor mount assembly in the counter-clockwise direction, the protrusion of the corresponding lock structure will be blocked by the blocking member 7248A and hence cannot rotate to align with the recess 7242A.

The engagement structure 724B has a counter-clockwise engagement design. As shown in FIG. 7B, the engagement structure 724B includes a side bump 7244B protruding from a peripheral surface of a shaft receiving member (not shown in FIG. 7B). A recess 7242B is formed on the side bump 7244B. The engagement structure 724B further includes a blocking member 7248B arranged at the left side of the recess 7242B, i.e., the clockwise side (seeing from above) of the recess 7242B. When the rotor blade assembly including the engagement structure 724B rotates relative to the corresponding rotor mount assembly in the counter-clockwise direction, the protrusion of the corresponding lock structure can pass over the side bump 7244B from the right side of the recess 7242B to align with the recess 7242B. However, further movement of the protrusion can be blocked by the blocking member 7248B when the protrusion contacts the blocking member 7248B. On the other hand, if the rotor blade assembly including the engagement structure 724B rotates relative to the corresponding rotor mount assembly in the clockwise direction, the protrusion of the corresponding lock structure will be blocked by the blocking member 7248B and hence cannot rotate to align with the recess 7242B.

In the example propulsion devices described above, the protrusions are formed on the rotor mount assembly and the recesses are formed on the rotor blade assembly. In some other embodiments, the locations of the protrusions and the recesses can be switched or changed. For example, the protrusions can be formed on the rotor blade assembly and the recesses can be formed on the rotor mount assembly.

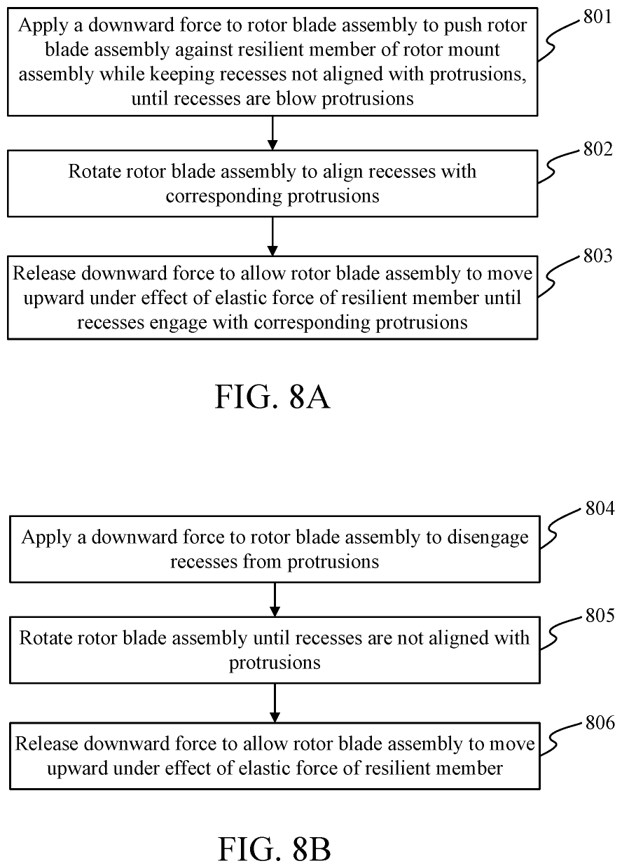

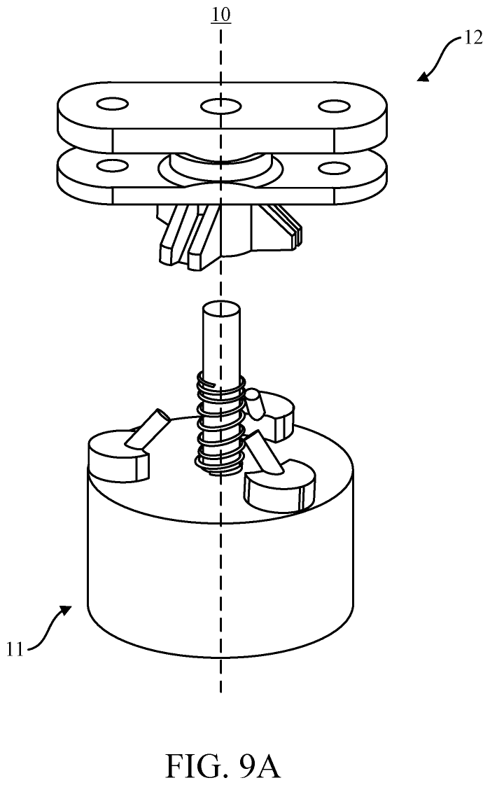

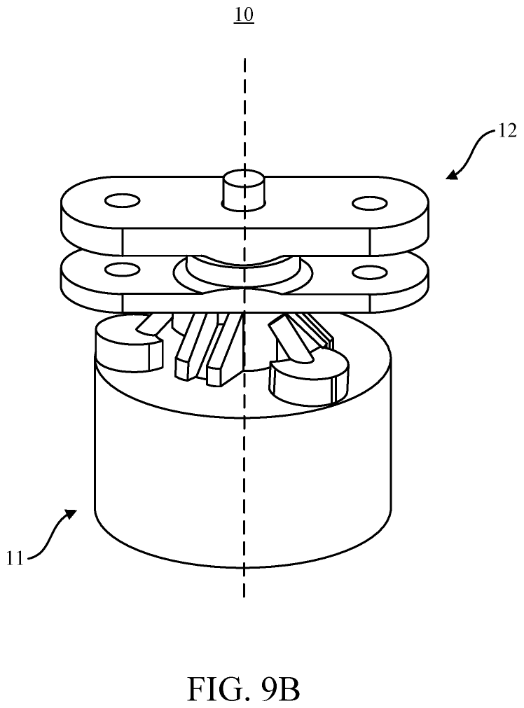

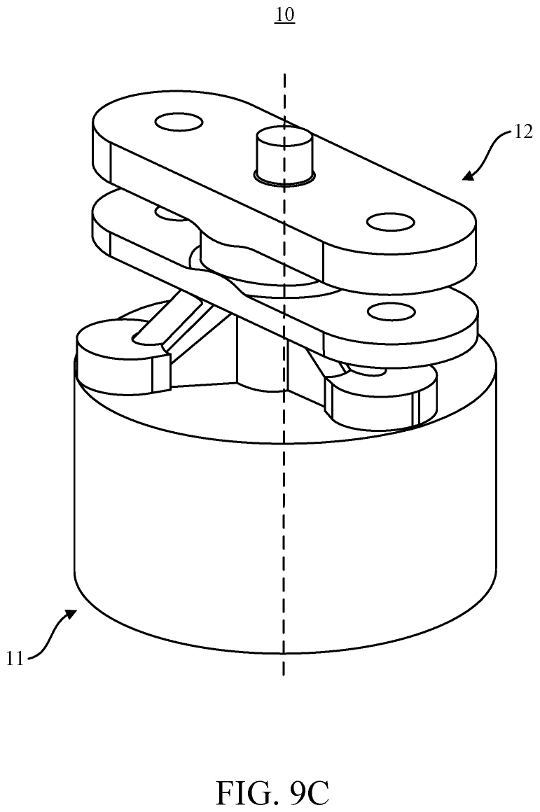

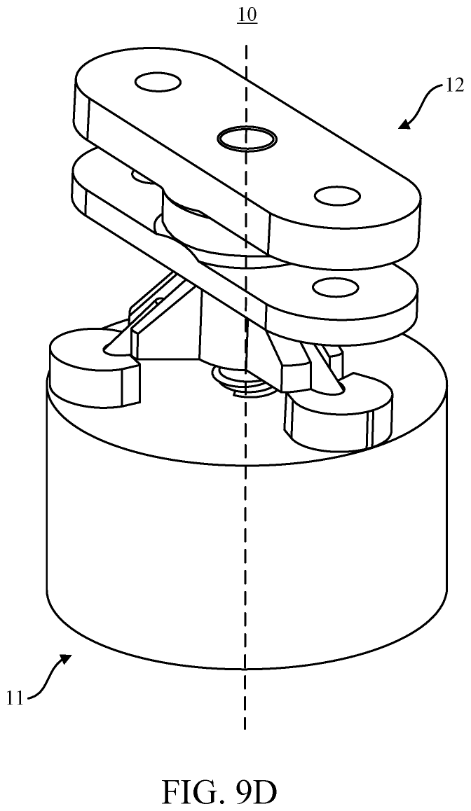

FIGS. 8A and 8B are flow charts showing an example method of using a propulsion device including a rotor mount assembly and a rotor blade assembly consistent with the disclosure. FIG. 8A shows the processes of assembling the propulsion device and FIG. 8B shows the processes of dissembling the propulsion device. The method is described below also with reference to FIGS. 9A-9D, which show the state of the propulsion device at different stages.

The method is described using the propulsion device 10 as an example, but is applicable to any propulsion device consistent with the disclosure.

To assemble the propulsion device, the shaft hole of the rotor blade assembly is aligned with the shaft of the rotor mount assembly, as shown in FIG. 9A. At this stage, the recesses of the rotor blade assembly do not need to align with the protrusions of the rotor mount assembly. For example, the recesses can be not aligned with the protrusions. Then, as shown in FIG. 8A, at 801, a downward force is applied to the rotor blade assembly to push the rotor blade assembly against the resilient member of the rotor mount assembly while keeping the recesses not aligned with the protrusions, until the recesses are below the protrusions. The state of the protrusion device after the process at 801 is shown in FIG. 9B. At 802, the rotor blade assembly is rotated to align the recesses with the corresponding protrusions, as shown in FIG. 9C. Then, at 803, the downward force is released to allow the rotor blade assembly to move upward under the effect of the elastic force of the resilient member until the recesses engage with the corresponding protrusions. The assembling process is thus completed, with the protrusion device now in the assembled state, as shown in FIG. 9D.

The dissembling process shown in FIG. 8B can basically be the opposite of the assembling process shown in FIG. 8A and described above. Beginning with the protrusion device being in the dissembled state shown in FIG. 9D, at 804, another downward force is applied to the rotor blade assembly to disengage the recesses from the protrusions, as shown in FIG. 9C. At 805, the rotor blade assembly is rotated until the recesses are not aligned with the protrusions, as shown in FIG. 9B. The rotation direction during the process at 805 can be opposite to the rotation direction during the process at 802. Then, at 806, the downward force is released to allow the rotor blade assembly to move upward under the effect of the elastic force of the resilient member. In some embodiments, an upward force can be applied to the rotor blade assembly in addition to the elastic force of the resilient member or when the resilient member is no longer able to push the rotor blade assembly, to pull the shaft of the rotor mount assembly out of the shaft hole of the rotor blade assembly, such that the rotor blade assembly is completely separated from the rotor mount assembly, and the propulsion device can be in the dissembled state as shown in FIG. 9A.

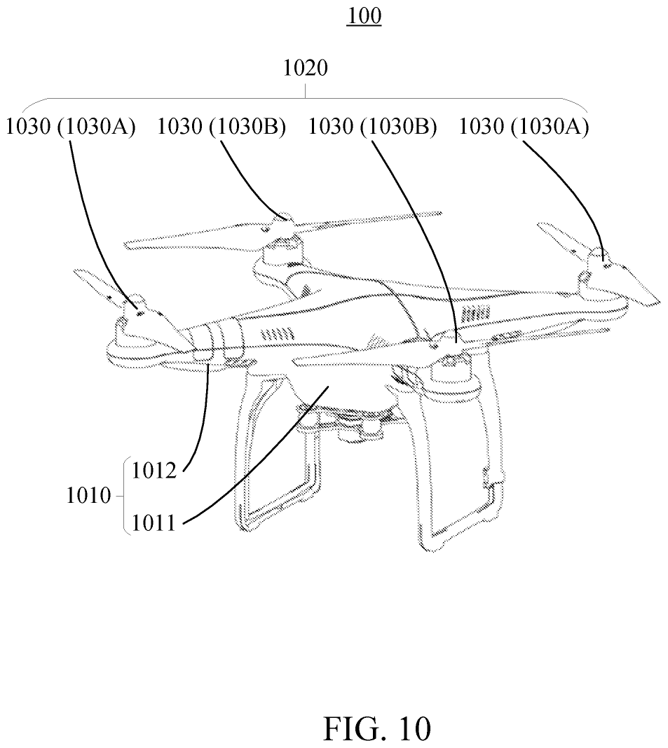

The propulsion device consistent with the disclosure, such as the propulsion device 10, 40, 50, or 60 described above, can be used in an aerial vehicle, such as an unmanned aerial vehicle (UAV), to provide lift force for the aerial vehicle. FIG. 10 schematically shows an example aerial vehicle 100 consistent with the disclosure. The aerial vehicle 100 includes a fuselage frame 1010 and a propulsion system 1020 coupled to the fuselage frame 1010 and configured to provide lift force for the aerial vehicle 100. The fuselage frame 1010 includes a vehicle body 1011 and a plurality of arms 1012 extending from the vehicle body 1011. The vehicle body 1011 can be configured to accommodate various components of the aerial vehicle 100, such as a flight controller, electronic circuitry, and/or one or more sensors. In some embodiments, a gimbal for carrying a payload, such as a camera, can be coupled to the vehicle body 1011, such as arranged below the vehicle body 1011.

The propulsion system 1020 includes a plurality of propulsion devices 1030 each arranged at or close to one end of one of the plurality of arms 1012 that is distal from the vehicle body 1011. Each of the propulsion devices 1030 can be the same as or similar to one or more of the propulsion devices 10, 40, 50, and 60 described above in connection with FIGS. 1A-9D, and can have the same or similar components as one or more of the propulsion devices 10, 40, 50, and 60 described above. For example, each of the propulsion devices 1030 can include a rotor mount assembly and a rotor blade assembly mounted thereto, and the rotor mount assembly can include a base, a lock structure disposed at the base, and a resilient member disposed at the base. The base of each of the propulsion device 1030 can include a motor as described above, such as an outer rotor motor. The lock structure can include a plurality of protrusions tilted with respect to the rotation plane of the rotor mount assembly. The rotor blade assembly can include a blade mount and an engagement structure disposed at the blade mount. The engagement structure can include a plurality of recesses tilted with respect to the rotation plane of the rotor blade assembly. The recesses correspond to the protrusions and are configured to engage/interface with the protrusions to lock the rotor blade assembly to the rotor mount assembly. The resilient member is configured to abut against and provide an elastic force to the rotor blade assembly to constrain the protrusions in the corresponding recesses. Detailed descriptions of the structure, configuration, and function of various components of each of the propulsion devices 1030 are omitted here.

In the example shown in FIG. 10, the aerial vehicle 100 is a four-rotor aerial vehicle including four arms 1012 and four propulsion devices 1030 each arranged at or close to one end of one of the four arms 1012 that is distal from the vehicle body 1011. In some other embodiments, the aerial vehicle 100 can be a two-rotor aerial vehicle including two propulsion devices 1030, a three-rotor aerial vehicle including three propulsion devices 1030, a six-rotor aerial vehicle including six propulsion devices 1030, or an eight-rotor aerial vehicle including eight propulsion devices 1030. In some embodiments, the plurality of propulsion devices 1030 can be arranged evenly spaced apart from each other. In some embodiments, the plurality of propulsion devices 1030 can be divided into two groups and the two groups can be arranged symmetric to each other with respect to a middle plane of the aerial vehicle 100.

In order to allow the aerial vehicle 100 to operate properly, for example, to balance the angular momentums created by the rotors of the plurality of propulsion devices 1030 during rotation, the plurality of propulsion devices 1030 should be configured to rotate in different directions while being able to generate upward thrust. For example, for the aerial vehicle 100 shown in FIG. 10, the two propulsion devices labeled 1030A may need to rotate in a first direction, such as a counter-clockwise direction (seeing from above), and the two propulsion devices labeled 1030B may need to rotate in a second direction that is different from the first direction, such as a clockwise direction (seeing from above). The two propulsion devices 1030A are also referred to as “first-direction propulsion devices” and can provide a lift force when rotating in the first direction. The base of each of the first-direction propulsion devices can include a first-direction motor that can rotate in the first direction when operating. The two propulsion devices 1030B are also referred to as “second-direction propulsion devices” and can provide a lift force when rotating in the second direction. The base of each of the second-direction propulsion devices can include a second-direction motor that can rotate in the second direction when operating.

In some embodiments, as shown in FIG. 10, the four propulsion devices 1030 are arranged around the vehicle body 1011 in the following order: a first-direction propulsion device 1030A, a second-direction propulsion device 1030B, a first-direction propulsion device 1030A, and a second-direction propulsion device 1030B. In some embodiments, the propulsion system 1020 of the aerial vehicle 100 can include two propulsion devices, one being a first-direction propulsion device and another one being a second-direction propulsion device.

To allow the first-direction propulsion device 1030A and the second-direction propulsion device 1030B to both provide upward thrust while rotating in different directions, the rotor blade assembly (also referred to as “first-direction rotor blade assembly”) of the first-direction propulsion device 1030A and the rotor blade assembly (also referred to as “second-direction rotor blade assembly”) of the second-direction propulsion device 1030B may have different configurations. For example, the blades of the first-direction rotor blade assembly may tilt in a different direction than the blades of the second-direction rotor blade assembly. If a first-direction rotor blade assembly is used in a second-direction propulsion device or vice versa, a downward thrust may be generated, instead of the intended upward thrust. This would result in malfunction of the aerial vehicle 100, and may cause damages to the aerial vehicle 100.

To avoid an incorrect rotor blade assembly being used in a propulsion device, the present disclosure also provides certain fool-proofing designs that can be applied to the propulsion devices 1030 of the propulsion system 1020. In some embodiments, the rotor mount assembly (also referred to as “first-direction rotor mount assembly”) of a first-direction propulsion device 1030A can be configured to not allow the second-direction rotor blade assembly to be assembled or mounted to the first-direction rotor mount assembly. In some embodiments, the rotor mount assembly (also referred to as “second-direction rotor mount assembly”) of a second-direction propulsion device 1030B can be configured to not allow the first-direction rotor blade assembly to be assembled or mounted to the second-direction rotor mount assembly. In some embodiments, both the first-direction rotor mount assembly and the second-direction rotor mount assembly can be configured to not allow the other-types of rotor blade assembly to be assembled or mounted thereto.

Various fool-proofing designs consistent with the disclosure can be employed. In some embodiments, at least one of the size or the shape of at least one protrusion of the first-direction propulsion device 1030A can be different from that of at least one protrusion of the second-direction propulsion device 1030B. In some embodiments, at least one of the size or the shape of each of the protrusions of the first-direction propulsion device 1030A can be different from that of each of the protrusions of the second-direction propulsion device 1030B. The size and/or the shape of the protrusion of the first-direction propulsion device 1030A can be configured to not allow the recess of the second-direction propulsion device 1030B to engage with that protrusion. Correspondingly, the size and/or the shape of the protrusion of the second-direction propulsion device 1030B can be configured to not allow the recess of the first-direction propulsion device 1030A to engage with that protrusion.

In some embodiments, the protrusions (and hence the recesses) of the first-direction propulsion device 1030A can have a different orientation than the protrusions (and hence the recesses) of the second-direction propulsion device 1030B. For example, the first-direction propulsion device 1030A can be one of the propulsion devices 10, 40, and 50 described above, and the second-direction propulsion device 1030B can be another one of the propulsion devices 10, 40, and 50. In one particular example, the first-direction propulsion device 1030A can be the propulsion device 40, i.e., a propulsion device including protrusions and recesses arranged to have a left-handed helicity and the second-direction propulsion device 1030B can be the propulsion device 50, i.e., a propulsion device including protrusions and recesses arranged to have a right-handed helicity. Since the handedness of the protrusions/recesses of the first-direction propulsion device 1030A is opposite to the handedness of the protrusions/recesses of the second-direction propulsion device 1030B, the protrusions of the first-direction propulsion device 1030A cannot engage with the recesses of the second-direction propulsion device 1030B, and vice versa.

In some embodiments, the protrusions/recesses of the first-direction propulsion device 1030A and the protrusions/recesses of the second-direction propulsion device 1030B can be arranged to have helicities with the same handedness, but the spatial angles of the protrusions/recesses of the two propulsion devices 1030A and 1030B are different. For example, angle α and/or angle β of a protrusion of the first-direction propulsion device 1030A can have an absolute value different from that of angle α and/or angle β of a protrusion of the second-direction propulsion device 1030B.

Fool-proofing can also be realized by configuring the propulsion devices 1030A and 1030B to require relative rotation between the corresponding rotor blade assembly and the corresponding rotor mount assembly in different directions during assembling. In some embodiments, the lock structure and the engagement structure of the first-direction propulsion device 1030A can be configured in such a manner that the engagement structure can only be rotated to the proper position and hence engage with the lock structure when the rotor blade assembly is pushed against the resilient member of the rotor mount assembly and rotated in a first direction. Correspondingly, the lock structure and the engagement structure of the second-direction propulsion device 1030B can be configured in such a manner that the engagement structure can only be rotated to the proper position and hence engage with the lock structure when the rotor blade assembly is pushed against the resilient member of the rotor mount assembly and rotated in a second direction opposite to the first direction. For example, the first direction can be the clockwise direction (seeing from above) and correspondingly the second direction can be the counter-clockwise direction (seeing from above). As another example, the first direction can be the counter-clockwise direction and correspondingly the second direction can be the clockwise direction. In some embodiments, the first-direction propulsion device 1030A can include the above lock structure 714A and engagement structure 724A that have the clockwise engagement design, and the second-direction propulsion device 1030B can include the above lock structure 714B and engagement structure 724B that have the counter-clockwise engagement design.

In a propulsion device according to the present disclosure, the protrusions of the lock structure (which can be on one of the rotor mount assembly and the rotor blade assembly as described above), and correspondingly the recesses of the engagement structure (which can be on the other one of the rotor mount assembly and the rotor blade assembly as described above) are tilted with respect to respective rotation planes toward or away from respective rotation axis. Thus, when the propulsion device is operating, the rotor blade assembly tends to align its rotation axis with the rotation axis of the rotor mount assembly. As such, vibration of the propulsion device during operation can be reduced or eliminated. Further, the locking between the lock structure and the engagement structure is ensured through a force pushing the rotor blade assembly upward. During operation, the rotor blade assembly has a tendency to move upward, pushing the recesses to abut against the protrusions even harder, and hence the engagement between the lock structure and the engagement structure is even further secured.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing times, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. For example, any two or more embodiments and/or features thereof described in this specification can be combined and/or exchanged in any suitable manner, as long as there is no conflict. It is intended that the specification and examples be considered as exemplary only and not to limit the scope of the disclosure, with a true scope and spirit of the invention being indicated by the following claims.

What is claimed is:

1. A propulsion system of an unmanned aerial vehicle (UAV) comprising:
a first propulsion device including:
a first rotor mount assembly including:
a first base; and
a first lock structure arranged at the first base, the first lock structure including a first protrusion protruding from the first base, an angle between an extension direction of the first protrusion and a first rotation plane of the first rotor mount assembly having an absolute value larger than 0° and smaller than 90°; and
a first rotor blade assembly configured to be locked to the first rotor mount assembly by the first lock structure; and
a second propulsion device including:
a second rotor mount assembly including:
a second base; and
a second lock structure arranged at the second base, the second lock structure including a second protrusion protruding from the second base, an angle between an extension direction of the second protrusion and a second rotation plane of the second rotor mount assembly having an absolute value larger than 0° and smaller than 90°; and
a second rotor blade assembly configured to be locked to the second rotor mount assembly by the second lock structure;
wherein the first rotor mount assembly is configured to not allow the second rotor blade assembly to be assembled to the first rotor mount assembly.

2. The propulsion system of claim 1, wherein:
the first protrusion is configured to engage with a first recess of the first rotor blade assembly to detachably attach the first rotor blade assembly to the first base; and
the second protrusion is configured to engage with a second recess of the second rotor blade assembly to detachably attach the second rotor blade assembly to the second base.

3. The propulsion system of claim 2, wherein at least one of a size or a shape of the first protrusion is different from that of the second protrusion, and the at least one of the size or the shape of the first protrusion is configured to not allow the second recess of the second rotor blade assembly to engage with the first protrusion.

4. The propulsion system of claim 1, wherein:
a line at which the first protrusion is located intersects a rotation axis of the first rotor mount assembly; and
a line at which the second protrusion is located intersects a rotation axis of the second rotor mount assembly.

5. The propulsion system of claim 1, wherein:
a first angle between a projection of the first protrusion on the first rotation plane and a first radial direction of the first rotation plane that passes through a joint point between the first protrusion and the first base has an absolute value larger than 0° and smaller than 90°, the first angle being on a clockwise side of the first radial direction; and
a second angle between a projection of the second protrusion on the second rotation plane and a second radial direction of the second rotation plane that passes through a joint point between the second protrusion and the second base has an absolute value larger than 0° and smaller than 90°, the second angle being on a counter-clockwise side of the second radial direction.

6. The propulsion system of claim 1, wherein:
the first protrusion is one of a plurality of first protrusions of the first lock structure that are arranged axisymmetrically about a rotation axis of the first rotor mount assembly; and
the second protrusion is one of a plurality of second protrusions of the second lock structure that are arranged axisymmetrically about a rotation axis of the second rotor mount assembly.

7. The rotor mount assembly of claim 6, wherein:
the plurality of first protrusions are arranged to have a left-handed helicity; and
the plurality of second protrusions are arranged to have a right-handed helicity.

8. The propulsion system of claim 1, wherein:
the first rotor mount assembly further includes a first resilient member arranged at the first base and configured to provide an elastic force on the first rotor blade assembly; and
the second rotor mount assembly further includes a second resilient member arranged at the second base and configured to provide an elastic force on the second rotor blade assembly.

9. The propulsion system of claim 8, wherein:
the first rotor mount assembly includes a first shaft arranged at a center of the first base, the first resilient member being sleeved on the first shaft; and
the second rotor mount assembly includes a second shaft arranged at a center of the second base, the second resilient member being sleeved on the second shaft.

10. The propulsion system of claim 1, wherein:
the first base includes a first motor; and
the second base includes a second motor.

11. The propulsion system of claim 10, wherein the first motor is an outer rotor motor and the first protrusion is disposed at an outer shell of the outer rotor motor.

12. The propulsion system of claim 10, wherein the second motor is an outer rotor motor and the second protrusion is disposed at an outer shell of the outer rotor motor.

13. The propulsion system of claim 1, wherein:
the first rotor blade assembly includes a first engagement structure configured to engage with the first lock structure, the first engagement structure including a first recess matching the first protrusion of the first lock structure; and
the second rotor blade assembly includes a second engagement structure configured to engage with the second lock structure, the second engagement structure including a second recess matching the second protrusion of the second lock structure.

14. The propulsion system of claim 13, wherein:
at least one of the first lock structure or the first engagement structure is configured such that the first protrusion is capable of engaging with the first recess when the first rotor blade assembly is rotating relative to the first rotor mount assembly in a first direction but not capable of engaging with the first recess when the first rotor blade assembly is rotating relative to the first rotor mount assembly in a second direction opposite to the first direction; and
at least one of the second lock structure or the second engagement structure is configured such that the second protrusion is capable of engaging with the second recess when the second rotor blade assembly is rotating relative to the second rotor mount assembly in the second direction but not capable of engaging with the second recess when the second rotor blade assembly is rotating relative to the second rotor mount assembly in the first direction.

15. The propulsion system of claim 14, wherein:
the first engagement structure includes a first blocking member arranged at one side of the first recess and configured to block the first protrusion from moving further when the first protrusion contacts the first blocking member during rotation of the first rotor blade assembly relative to the first rotor mount assembly in the first direction; and
the second engagement structure includes a second blocking member arranged at one side of the second recess and configured to block the second protrusion from moving further when the second protrusion contacts the second blocking member during rotation of the second rotor blade assembly relative to the second rotor mount assembly in the second direction.

16. The propulsion system of claim 13, wherein:
a cross-section of the first recess matches a cross-section of the first protrusion; and
a cross-section of the second recess matches a cross-section of the second protrusion.

17. An unmanned aerial vehicle (UAV) comprising:
a fuselage frame; and
the propulsion system of claim 1 coupled to the fuselage frame.

18. The UAV of claim 8, wherein:
the fuselage frame includes:
a vehicle body; and
at least two arms extending from the vehicle body; and
each of the first propulsion device and the second propulsion device is arranged at one end of one of the at least two arms that is distal from the vehicle body.

19. The UAV of claim 9, wherein:
the at least two arms include four arms extending from the vehicle body;
the propulsion system further includes:
a third propulsion device, the first propulsion device and the third propulsion device having an approximately same structure and being configured to rotate in a first direction; and
a fourth propulsion device, the second propulsion device and the fourth propulsion device having an approximately same structure and being configured to rotate in a second direction opposite to the first direction;
each of the first propulsion device, the second propulsion device, the third propulsion device, and the fourth propulsion device is arranged at one end of one of the four arms that is distal from the vehicle body; and
the first propulsion device, the second propulsion device, the third propulsion device, and the fourth propulsion device are arranged around the vehicle body in that order.

20. The UAV of claim 10, wherein the first propulsion device, the second propulsion device, the third propulsion device, and the fourth propulsion device are arranged evenly spaced apart from each other.
